(19) United States
(12) Patent Application Publication
(10) Pub. No.: US 2021/0017042 A1
(43) Pub. Date: Jan. 21, 2021

(54) Liquid Filtering Device And Filtering System Using The Same

(71) Applicant: Share Light co., LTD., Gyeonggi-do (KR)

(72) Inventor: Eun Hyun PARK, Gyeonggi-do (KR)

(21) Appl. No.: 16/919,442

(22) Filed: Jul. 2, 2020

(30) Foreign Application Priority Data
Jul. 15, 2019 (KR) 10-2019-0085230
May 27, 2020 (KR) 10-2020-0063623

(51) Int. Cl. C02F 1/00; B01D 39/08; B01D 29/01

(52) U.S. Cl. CPC C02F 1/003; B01D 39/08; B01D 2239/06; C02F 2307/02; B01D 29/01

(57) ABSTRACT

Disclosed is a filter arrangement comprising: a first body, into which an inlet of the first container for containing liquid is inserted and coupled together in a sealing manner, the first body including an inlet, an outlet and a lower face formed on the outlet; a second body, into which an inlet of the second container is inserted and coupled together in a sealing manner, the second body including an inlet, an outlet and an upper face formed on the inlet; a passage fluidly connecting the inlet of the first body, the outlet of the first body, the inlet of the second body and the outlet of the second body; a filter provided on the lower face of the first body and the upper face of the second body; and a plurality of raised bumps provided between the filter and the upper face of the second body.

### CROSS REFERENCE TO RELATED APPLICATION

This application is claims the benefit of and priority of Korean Patent Application No. 10-2020-0063623, filed on May 27, 2020 and Korean Patent Application No. 10-2019-0085230, filed on Jul. 15, 2019. The entire disclosures of the applications identified in this paragraph are incorporated herein by references.

### FIELD

The disclosure relates generally to a filter arrangement and a water purification system using the same. More specifically, it relates to an easy-to-operate filter arrangement for filtering liquid and a water purification system using the same.

### BACKGROUND

This section provides background information related to the present disclosure which is not necessarily prior art.

FIG. 1 illustrates an example of a portable purification filter described in Korean Patent Publication No. 10-2009-0095747, in which the portable purification filter 1 includes a filtration part 20, a discharge part 10, and a top cover 30. The filtration part 20 having an outer diameter flaring upwards is adapted to receive and filter unpurified water or other beverages from outside. The discharge part 10 is integrally coupled to the bottom portion where the water or other beverages are collected and has a tube form to be received into the mouth on top of a PET bottle container, allowing purified water or beverage to flow into the PET bottle container.

A joint 23, a filter paper 50, an annular groove for fixation 25, and a fixing frame 35 are provided between the filtration part 20 and the top cover 30. The top cover 30 is connected to joint 23 which is a part of the outer circumference and covers the upper area of the filtration part 20. Moreover, the upper cover 30 is detachable from the filtration part 20. The filter paper 50 has a shape that conforms to the contour of the filtration part 20. The annular groove for fixation 25 may be in form of a protruding groove having a defined dimension, along the inner peripheral surface of the upper end of the filtration part 20. The fixing frame 35 is placed on the rim of the filter paper 50 in order to firmly secure the filter paper 50 within the filtration part 20.

FIG. 2 illustrates an example of a filter for PET bottle containers described in Korean Patent Publication No. 10-2018-0102533, in which the filter 60 for PET bottle containers is mounted on an inlet opening I of a PET bottle container P for discharging only the water within the PET bottle container P, with the filter 60 having dimensions to make a tight or force fit into the inlet opening I. Typically, PET bottle containers P for beverages have standardized dimensions worldwide and use common-size caps. The filter 60 for the PET bottle container would have a diameter of 25 mm as the inlet opening I of the PET bottle container P has a standardized diameter of 25 mm. In addition, the filter 60 preferably has a thickness between 3 and 5 mm. After the filter is placed on the inlet opening I, the cap C is closed such that the filter is securely mounted onto the inlet opening I. The bottom of the filter 60 for the PET bottle container is slanted on either sides toward the virtual central axis.

The portable purification filter 1 shown in FIG. 1 can be arranged on top of a container for purifying contaminated water such that purified water may be received into the container through the filter 1. One issue with this portable purification filter 1 is that the user must hold the filter 1 to prevent it from tipping over. Meanwhile, the filter 60 for the PET bottle container shown in FIG. 2 is provided within the container such the user may drink purified water from the container directly with or without using a cup, etc. However, it is not easy to take this filter 60 out of the container especially when the user wants to reuse both later.

### SUMMARY

This section provides a general summary of the disclosure and is not a comprehensive disclosure of its full scope or all of its features.

According to one aspect of the present disclosure, there is provided a filter arrangement provided with an inlet and placed between a first container for containing liquid and a second container having an inlet, the filter arrangement comprising: a first body, into which an inlet of the first container for containing liquid is inserted and coupled together in a sealing manner, the first body including an inlet, an outlet and a lower face formed on the outlet; a second body, into which an inlet of the second container is inserted and coupled together in a sealing manner, the second body including an inlet, an outlet and an upper face formed on the inlet; a passage fluidly connecting the inlet of the first body, the outlet of the first body, the inlet of the second body and the outlet of the second body, the passage being used for the liquid and air to travel therethrough; a filter provided on the lower face of the first body and the upper face of the second body, for filtering impurities present in the liquid; and a plurality of raised bumps provided between the filter and the upper face of the second body such that the filter and the upper face of the second body are separated from each other.

According to another aspect of the present disclosure, there is provided a water purification system comprising: a filter arrangement described in any of claims 1 to 9; a first container connected to one end of the filter arrangement; and a second container connected to the other end of the filter arrangement, wherein the first container and the second container are at least partially made from a material that may cause volume deformation by the application of pressure.

### BRIEF DESCRIPTION OF THE DRAWINGS

FIG. 1 illustrates an example of a portable purification filter described in Korean Patent Publication No. 10-2009-0095747.

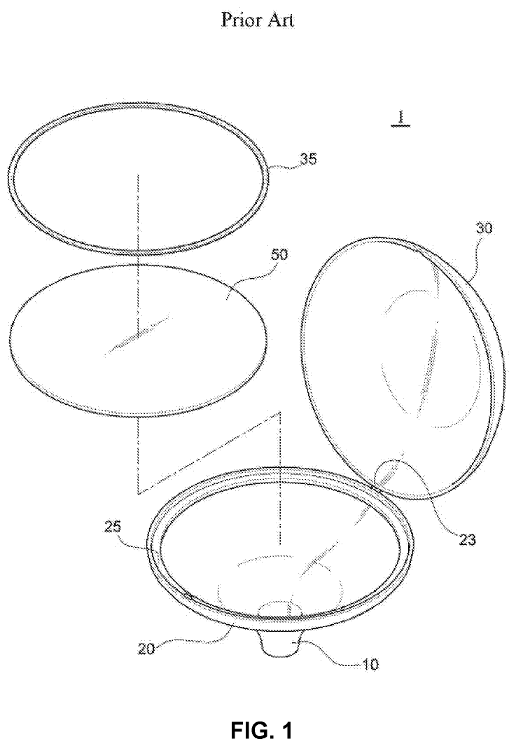

FIG. 2 illustrates an example of a filter for PET bottle containers described in Korean Patent Publication No. 10-2018-0102533.

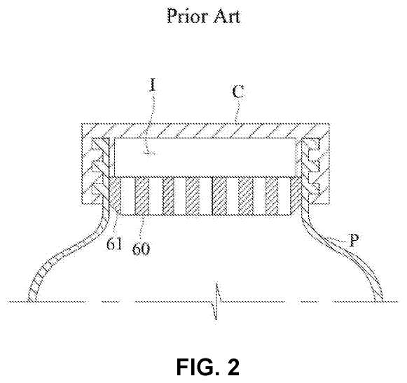

FIG. 3 illustrates an exemplary embodiment of a water purification system according to the present disclosure.

FIG. 4 illustrates an exemplary embodiment of a filter arrangement according to the present disclosure.

FIG. 5 illustrates another exemplary embodiment of a filter arrangement according to the present disclosure.

FIG. 6 shows an example of how to use the filter arrangement according to the present disclosure.

FIG. 7 illustrates yet another exemplary embodiment of a filter arrangement according to the present disclosure.

FIG. 8 shows the operation of the filter arrangement of FIG. 7 according to movement of the fluid.

FIG. 9 illustrates a top view of the second body of the filter arrangement of FIG. 7.

FIG. 10 illustrates another top view of the second body of the filter arrangement of FIG. 7.

FIG. 11 illustrates still another exemplary embodiment of a filter arrangement according to the present disclosure.

### DETAILED DESCRIPTION

The present disclosure will now be described in detail with reference to accompanying drawing(s).

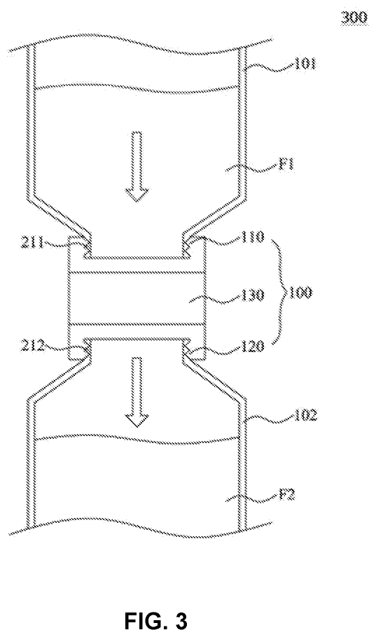

FIG. 3 illustrates an exemplary embodiment of a water purification system 300 according to the present disclosure.

The water purification system 300 includes a filter arrangement 100, a first container 101, and a second container 102.

The filter arrangement 100 includes a first body 110, a second body 120, and a main filter 130. The first body 110 is connected to the first container 101 and provided at one end of the filter arrangement 100. The second body 120 is connected to the second container 102 and provided at the other end (lower side in FIG. 3) of the filter arrangement 100.

The first container 101 contains liquid, and the second container 102 also contains liquid. In particular, the first container 101 may contain a liquid F1 with impurities, and second container 102 may contain a liquid F2 with less impurities than the liquid F1 in the first container 101. For example, the liquid F1 with impurities contained in the first container 101 may be contaminated water, and the liquid F2 with less impurities contained in the second container 102 may be filtered water.

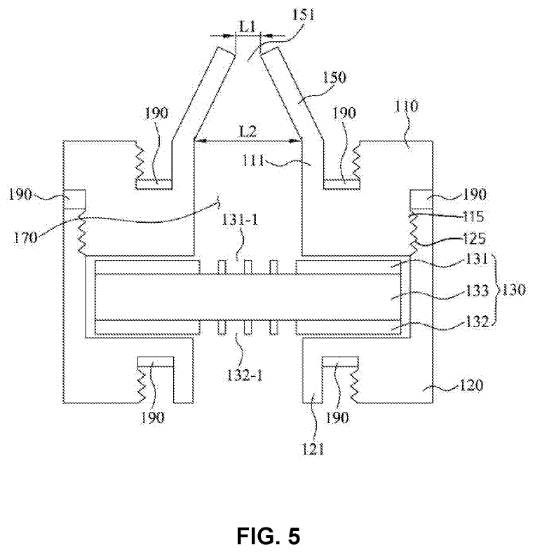

The main filter 130 provided between the first body 110 and the second body 120 serves to filter impurities from the impurity-containing liquid. The main filter 130 includes a filter 133 (see FIG. 5) capable of filtering impurities. Further, the main filter 130 is washable and reusable, and the filter 133 may be a stack of multiple layers of materials. For example, the filter 133 may include different filter materials. Examples of the filter material for layers may include a metal, plastic mesh, activated carbon having an antibacterial effect and adsorbing impurities, microfiltration membrane (MF membrane) and an ultrafiltration membrane (UF membrane). Alternatively, sponges having fine holes, regular sponges, fabric, activated carbon, or the like may also be employed as the filter 133. In particular, microfiber cloth may be a preferable filter material as it is dense and tough, has a thickness of no larger than a few microns that makes it useful for trapping or filtering impurities, and can be washable and reusable like a new one after use. Additionally, or alternatively, the filter 133 may include a combination of different filter materials, or the filter 133 may include a plurality of filters 133 connected in series, each being made from different filter materials. In one example, the plurality of filters 133 may include a filter 133 made from a fiber material, a filter 133 having a microfiltration membrane or an ultrafiltration membrane, and a filter 133 having activated carbon inside, which are connected in series and contribute to adjustment of the purification level of water, as needed. These filters 133 may be connected to each other with a connector (not shown).

The first container 101 and the second container 102 to which the first body 110 and the second body 120 are connected, respectively, can be PET bottles, and the first container 101 and the second container 102 are preferably formed from a flexible material, being easily deformed when squeezed by hand. Any material, without limitation, may be used for the first and second containers 101, 102 as long as it allows at least part of the containers to be easily deformed under the applied pressure.

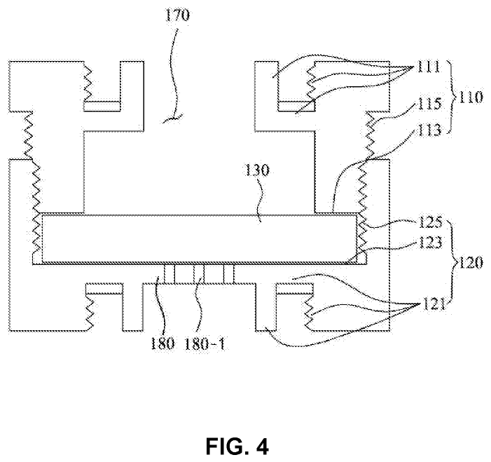

FIG. 4 illustrates an exemplary embodiment of a filter arrangement according to the present disclosure.

In this example, the first body 110 and the second body 120 are separable from each other, and the main filter 130 is provided between the first body 110 and the second body 120. To retain the main filter 130 securely between the first body 110 and the second body 120, the main filter 130 has one side abutting to at least one face 113 of the first body 110 and another side abutting to at least one face 123 of the second body 120. Preferably, the first body 110 and the second body 120 are connected in a way that the face 113 of the first body 110 compresses the main filter 130 onto the face 123 of the second body 120, in order to ensure that the liquid F1 (see FIG. 3) containing impurities always passes through the main filter 130 instead of going around the main filter and not having been filtered. In result, the liquid F1 containing impurities will not be escaped between the face 113 of the first body 110 and the main filter 130.

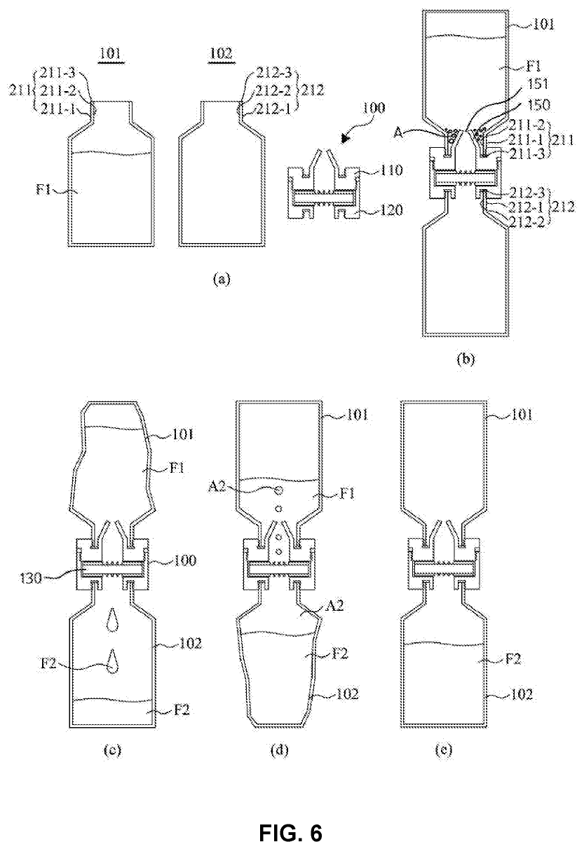

The first body 110 includes a first coupling part 111, into which at least a portion of an inlet 211 (see FIG. 6) of the first container 101 is inserted and coupled together with the first body 110.

The first coupling part 111 is joined with an outer face 211-1, an inner face 211-2, and an end 211-3 of the inlet 211 of the first container 101 shown in FIG. 6. A portion of the first coupling part 111 that comes into contact with the outer face 211-1 may be threaded. The inner face 211-2 and the end 211-3 may serve to secure the first container 101 and enhance its sealing, preventing leakage of liquid and air to outside.

The second body 120 has a second coupling part 121, into which at least a portion of an inlet 212 (see FIG. 6) of the second container 102 is inserted and coupled together.

The second coupling part 121 is joined with an outer face 212-1, an inner face 212-2, and an end 212-3 of the inlet 212 of the second container 102 shown in FIG. 6. A portion of the second coupling part 121 that comes into contact with the outer face 212-1 may be threaded. The inner face 212-2 and the end 212-3 may serve to secure the second container 102 and enhance its sealing, preventing leakage of liquid and air to outside. More details associated with the sealing process will be provided below with reference to FIG. 6.

A passage 170 runs through the first body 110 and the second body 120, and at least one of water and air travels through the passage 170. The entrance of the passage 170 is surrounded with the second coupling part 121.

The first body 110 has a third coupling part 115, and the second body 120 has a fourth coupling part 125. The third coupling part 115 and the fourth coupling part 125 are adapted to couple the first body 110 and the second body 120 together. In addition, the third coupling part 115 and the fourth coupling part 125 may enter engagement while rotating.

A support 180 is placed beneath the main filter 130. The support 180 is configured to prevent the main filter 130 from falling out towards the second coupling part 121 of the passage 170. The support 180 may have a plurality of holes 180-1, and at least one of water and air can travel through the plurality of holes 180-1. Further, the support 180 may be formed integrally with the second body 120.

FIG. 5 illustrates another exemplary embodiment of a filter arrangement according to the present disclosure.

The first body 110 has a first coupling part 111, in which the first container 101 (see FIG. 6) is received. The first coupling part 111 may be provided with an elastic element 190. The elastic element 190 is arranged between the first container 101 and the first body 110 to provide sealing effects such that water would be safely retained in the first container 101 without leaking between the first container 101 and the first body 110. This elastic element 190 may be formed from rubber, silicone, or the like.

The second body 120 has a second coupling part 121, in which the second container 102 (see FIG. 6) is received. The second coupling part 121 may be provided with an elastic element 190. The elastic element 190 is arranged between the second container 102 and the second body 120 such that water would be safely retained in the second container 102 without leaking between the second container 102 and the second body 120.

An elastic element 190 may be arranged between the third coupling part 115 and the fourth coupling part 125 to provide sealing effects such that liquid traveling from the first container 101 to the second container 102 would not leak between the third coupling part 115 and the fourth coupling part 125.

The main filter 130 may include a filter 133, a first plate 131 and a second plate 132. The first plate 131 is provided on the filter 133, and the second plate 132 is provided beneath the filter 133. The first and second plates 131, 132 fix the filter 133 in its place so that the filter 133 would not fall out.

When there is a space between the main filter 130 and the first body 110 and between the main filter 130 and the second body 120, the liquid F1 containing impurifies might flow into this space. In order to prevent this, it is preferable that the first plate 131 should be clung to or tightly attached to the first body 110 and the filter 133, and the second plate 132 should be clung to or tightly attached to the second body 120 and the filter 133. The first plate 131 and the second plate 132 may be made from an elastic material including, without limitation, silicone, rubber, plastics, or metals. With this configuration, it is possible to keep the liquid F1 (see FIG. 6) containing impurities from going around the filter 133, entering the space between the filter 133 and the first body 110 and between the filter 133 and the second body 120 and then flowing into the second container 102, and to prevent the material forming the filter 133 from escaping.

The first plate 131 and the second plate 132 provided in the passage 170 have a plurality of holes 131-1 and 132-1, respectively. The first plate 131 and the second plate 132 allow at least one of water and air to go through the holes 131-1, 132-1, which are designed to keep impurities with larger particles from entering the filter 133.

A supplemental filter 150 is provided, extending from the first coupling part 111 that surrounds the passage 170 and projecting toward the first container 101. The supplemental filter 150 has an inlet 151 to allow water to pass it through. Having a smaller width L1 at the inlet 151 than the width L2 at the entrance of the passage 170, the supplemental filter 150 can perform initial filtering of the impurities within the first container 101, such as, sprigs, leaves, sand, soil particles, etc., before the main filter 130 begins to clog up. The supplemental filter 150 may be designed to have slanted sides such that the impurities would be accumulated on the slanted sides, instead of getting into the filter.

FIG. 6 shows an example of how to use the filter arrangement according to the present disclosure.

Referring first to FIG. 6A, the filter arrangement 100 including the first body 110 and the second body 120, the first container 101 filled with the liquid (i.e., water) F1 containing impurities, and the second container 102 which is empty are brought together.

Next, as shown in FIG. 6B, the first container 101 filled with the water F1 containing impurities is connected to the first body 110 of the filter arrangement 100, and the second container 102 is connected to the second body 120 of the filter arrangement 100. The contaminated water F1 within the first container 101 may contain impurities A (e.g. sand, mud, fallen leaves, springs, etc.). Under the gravity, any impurity that is heavier than water will descend to the inlet 211 of the first container 101. Instead of being directed to the inlet 151 of the supplemental filer 150, the impurities are accumulated on the slanted sides of the supplemental filter 150 which is stretched out toward the first container 101, allowing only the contaminated water F1 to enter the inlet 151.

As shown in FIG. 6C, external pressure is then applied to the first container 101 where the contaminated water F1 is received. The contaminated water F1 is filtered through the filter arrangement 100, and the resulting filtered water F2 is received into the second container 102. When the first container 101 is subjected to the external pressure, the liquid (or water) F1 containing the impurities A passes through the main filter 130 and flows, as filtered water F2, into the second container 102. Due to the displacement of the water, the internal pressure in the first container 102 is decreased, while the internal pressure in the second container 102 is increased. At this point, it is critical to retain and seal the air and water within the first and second containers 101, 102, preventing water and air leaks to outside. Typically, denser filters 133 (see FIG. 5) require higher pressure.

Referring next to FIG. 6D, air A2 inside the second container 102 is now transferred to the first container 101 through the main filter 130. This is accomplished by pressing or applying external pressure to the second container 102 having an increased internal pressure. As a result, air pressure between the first container 101 and the second container 102 is balanced again, or the internal pressure in the first container 101 becomes higher than the internal pressure in the second container 102. After all, with repeated processes shown in FIGS. 6C and 6D, passage of contaminated water from the first container 101 to the second container 102 can be facilitated, without an inflow of outside air or a separate pressure regulator.

When the second container 102 is filled with the filtered water F2 as shown in FIG. 6E, the first container 101 and the second container 102 should no longer be subjected to external pressure. Here, the filtered water F2 in the second container 102 may be used as drinking water. Additionally, or alternatively, the filtered water F2 in the second container 102 may pass through the filter once again and flow back to the first container 101 for another filtration process.

The term ‘seal’ herein is intended to refer to a state in which water and/or air is still allowed to move from the first container 101 to the second container 102, or from the second container 102 to the first container 101, when external pressure is applied to the first container 101 and the second container 102. For example, with the first container 101 being pressed, water present in the first container 101 will still be transferred to the second container 102 via the filter, even if a portion of the air within the first container 101 must have been discharged. Likewise, with the second container 102 being pressed, air in the second container 102 will still be transferred to the first container 101 via the main filter 130, even if a portion of air within the second container 102 must have been discharged.

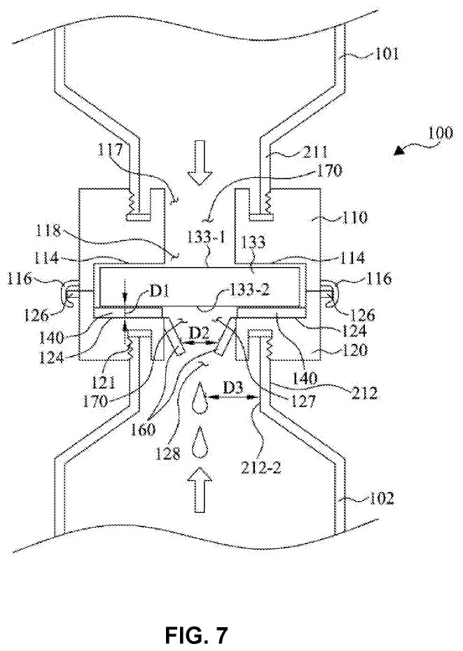

FIG. 7 illustrates yet another exemplary embodiment of a filter arrangement 100 according to the present disclosure.

The filter arrangement 100 includes a first body 110, a second body 120, a passage 170, a filter 133, and a plurality of raised bumps 140.

The first body 110 is connected to an inlet 211 of the first container 101 in a sealing manner. The first body 110 includes an inlet 117 and an outlet 118, allowing fluid inflows or outflows therethrough.

The second body 120 is connected to an inlet 212 of the second container 102 in a sealing manner. The second body 120 includes an inlet 127 and an outlet 128, allowing fluid inflows or outflows therethrough. The second body 120 may be located under the first body 110.

The first body 110 and the second body 120 are fluidly connected to each other with the passage 170, and the fluid runs through the passage 170. The passage 170 is extended from the inlet 111 of the first body to the outlet 122 of the second body 120. The fluid in the passage 170 may move in any direction. In particular, the passage 170 is formed between the inlet 117 and the outlet 118 of the first body 110, and between the inlet 127 and the outlet 128 of the second body 120.

The filter 133 lies on the passage 170 to filter impurities present in the fluid (e.g. liquid). The filter 133 may be made from fabric. For example, the filter 133 may be formed of microfiber. The filter 133 is arranged between a lower face 114 of the first body 110 and an upper face 124 of the second body 120. More details on the filter 133 are found in the description with respect to FIG. 3. The filter 133 includes an upper face 133-1 and a lower face 133-2.

The plurality of raised bumps 140 is located on the upper face 124 of the second body 120. These raised bumps 140 enable the fluid to pass throughout the entire filter 133.

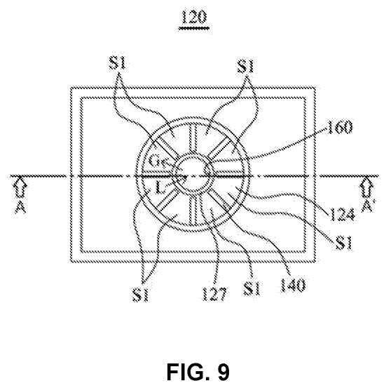

In addition, the plurality of raised bumps 140 are located between the filter 133 and the upper face 124 of the second body 120 such that the filter 133 is separated from the second body 120. The cross-sectional view of the second body 120 shown in FIG. 7 is taken along line AA′ across the second body 120 in FIG. 9.

In case of the filter arrangement 100 of FIG. 6, the filter 133 is tightly attached between the first body 110 and the second body 120. In other words, the filter 133 is clung to the lower face 114 of the first body 110 and to the upper face 124 of the second body 120, which causes only the central area of the filter 133 to filter the impurities. Because of this configuration, the fluid only runs through the central area of the filter 133, leaving the impurities accumulated on the filter 133 and increasing the pressure. This means that a greater force must be exerted to press the first container 101.

For the filter arrangement 100 of FIG. 7, however, the plurality of raised bumps 140 is provided on the second body 120 such that the second body 120 and the filter 133 are spaced apart from each other by a distance D1. This configuration allows the fluid to be discharged even through the filter 133 that has been tightly attached to the upper face 124 of the second body 120, and to move from the outlet 118 of the first body 110 to the upper face 124 of the second body 120. Therefore, the fluid is now able to travel across a bigger space, lowering the pressure. This means that the first container 101 shown in FIG. 6 can be pressed with a reduced force.

The second body 120 may further include an antistatic element 160. In addition, the second body 120 includes a second coupling part 121 engaged with the second container 102. In particular, the second coupling part 121 is engaged with an inlet 212 of the second container 102. The inlet 212 has an inner face 212-2. The antistatic element 160 is formed such that the fluid flows downstream without touching and flowing along the inner face 212-2 of the second container 102. With this configuration, the user can easily find out how much of the water, for example, has dropped into the second container 102, and whether the water is being filtered or not especially when the sound of a water dropping into the second container 102 has been made noticeable. The antistatic element 160 is preferably formed in a tapered shape, gradually decreasing in width D2, as it is inserted into the second container 102. This is to increase a distance D3 between the inner face 212-2 of the second container 102 and the filtered water.

Although not shown, the first body 101 and the second body 102 may be connected together in a sealing manner. For example, the first body 101 may include rotatory wings 116 sticking out of the first body 101 and the second body 102 may include projections 126 sticking out of the second body 102, with the wings 116 of the first body 101 covering over and fitting into the projections 126 of the second body 102 to secure and seal the first body 101 and the second body 102 together.

Apart from the configurational features described above, the filter arrangement 100 illustrated in FIG. 7 is substantially the same as the filter arrangement 100 illustrated in FIG. 3.

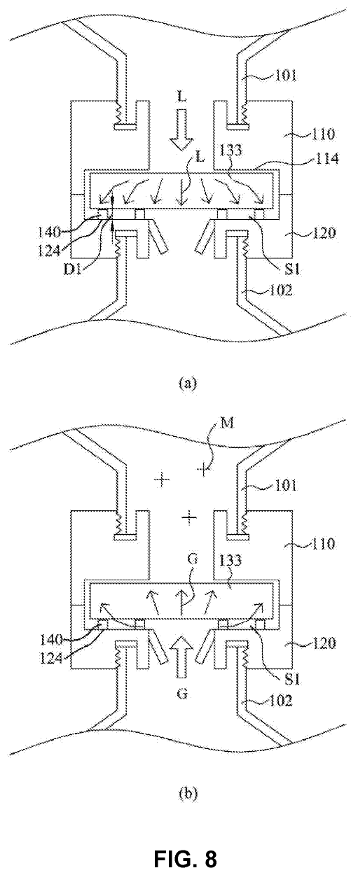

FIG. 8 shows the operation of the filter arrangement of FIG. 7 according to movement of the fluid.

The fluid herein includes both liquid L and gas G. One example of the liquid L would be water, and one example of the gas G would be air.

FIG. 8A illustrates filtration of the liquid L of the first container 101 by the filter 133 as the liquid L in the fluid is introduced into the filter 133. Here, the liquid L does not pass through the filter 133 due to the pressing force, but it is rather absorbed between the entire filter 133 and the lower face 114 of the first body 110, and then discharged between the filter 133 and the upper face 124 of the second body 120. Similar to one shown in FIG. 6C, the liquid L will pass through the filter 133 once the first container 101 is deformed by external force.

The lower face 114 of the first body 110 is closely attached to the filter 133. As a result, the liquid L would enter the filter 133 and pass not only through the central area of the filter 133 but also through the edges of the filter 133, as indicated with the arrows.

While the filter 133 and the lower face 114 of the first body 110 look as if there is a gap between them in the drawing, this is simply for clarifying these two components. In practice, they are closely attached to each other.

FIG. 8B illustrates another filtration as the gas G in the second container 102 passes through the filter 133. While the gas G is going through the filter 133, some of impurities M present in the filter 133 can be taken away into the first container 101. The gas G can also pass through the edges of the filter 133 via the space defined by D1 between the upper face 124 of the second body and the plurality of raised bumps 140. Then, similar to one shown in FIG. 6D, the gas G will pass through the filter 133 once the second container 102 is pressed.

FIG. 9 illustrates a top view of the second body of the filter arrangement of FIG. 7.

As the filter 133 (see FIG. 7) is supported by the plurality of raised bumps 140, a space 51 defined by the height D1 (see FIG. 7) of the raised bump 140 is created between the filter 133 and the upper face 124 (see FIG. 7) of the second body 120 (see FIG. 7). Because of the presence of these raised bumps 140, the filter 133 that might have gotten wet by the liquid L may still be kept separated from the upper face 124 of the second body 120.

Further, the gas G may also enter the space 51 between the upper face 124 of the second body 120 and the filter 133 so as to remove the impurities present in the filter 133, or the gas G may be transferred into the first container 101. The entire area of the filter 133 may be used equally or evenly for passage of the gas G since the filter 133 is not tightly attached to the upper face 124 of the second body 120.

The plurality of raised bumps 140 may be formed such that the liquid L would be spread across a larger space from the center to edges of the filter 133. These raised bumps 140 can be arranged in radial direction.

Additionally, a plurality of raised bumps 140 (not shown) can also be formed on the lower face 114 of the first body 110, similar to the plurality of raised bumps 140 formed on the second body 120.

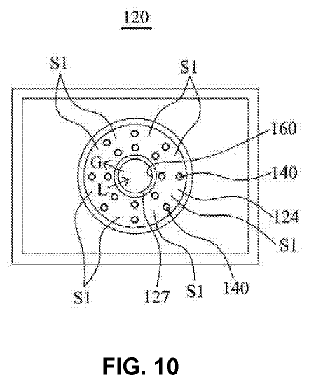

FIG. 10 illustrates another top view of the second body, according to the present disclosure.

In this embodiment, the plurality of raised bumps 140 has a dot shape, unlike the bar shape as shown in FIG. 9. Again, a space 51 defined by the height D1 (see FIG. 7) of the raised bump 140 is created between the filter 133 and the upper face 124 of the second body 120. However, the space 51 here can be larger, as much proportionally as the reduction in size of the plurality of raised bumps 140.

Apart from the configurational features described above, the second body 120 illustrated in FIG. 10 is substantially the same as the second body 120 illustrated in FIG. 9.

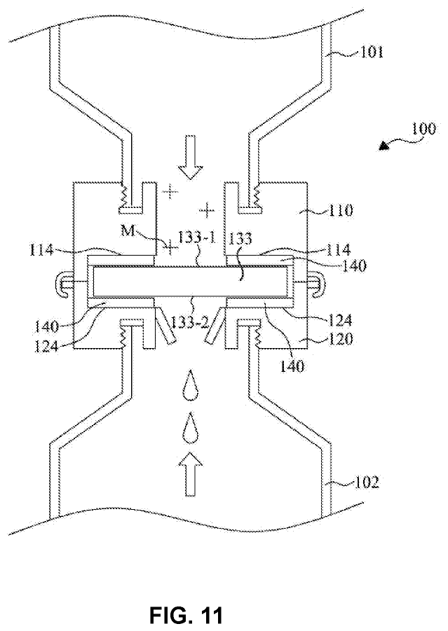

FIG. 11 illustrates still another exemplary embodiment of a filter arrangement according to the present disclosure.

In this embodiment, a plurality of raised bumps 140 is further formed on the lower face 114 of the first body 110, in addition to the second body 120.

By keeping the upper face 133-1 of the filter 133 separated from the first body, the plurality of raised bumps 140 allows the fluid to pass through the edges of the filter 133 as well.

Thus, without an increased pressure as the air below the filter 133 moves upward through the filter 133, the upper face 133-1 of the filter 133 will not cling to the lower face 114 of the first body 110, similar to one shown in FIG. 6D. Accordingly, the air is now able to flow easily between the lower face 114 of the first body 110 and the filter 133, which means that the second container 101 can be pressed with a smaller force than in FIG. 6. In particular, when air flow is created across the entire upper face 133-1 of the filter 133, it is easier to get rid of the impurities M present on the upper face 133-1 of the filter 133, and water filtration can be done with a shorter amount of time.

The rear view of the plurality of raised bumps 140 arranged on the first body 110 will look similar to those shown in FIG. 9 and FIG. 10.

Apart from the configurational features described above, the filter arrangement 100 illustrated in FIG. 11 is substantially the same as the filter arrangement 100 illustrated in FIG. 7.

Set out below are a series of clauses that disclose features of further exemplary embodiments of the present disclosure, which may be claimed.

(1) A filter arrangement provided with an inlet and placed between a first container for containing liquid and a second container having an inlet, the filter arrangement comprising: a first body, into which an inlet of the first container for containing liquid is inserted and coupled together in a sealing manner, the first body including an inlet for receiving the liquid from the first container, an outlet through which the liquid flowing from the inlet is discharged, and a lower face formed on the outlet; a second body, into which an inlet of the second container is inserted and coupled together in a sealing manner, the second body including an inlet for receiving the liquid, an outlet through which the liquid flowing from the inlet is discharged, and an upper face formed on the inlet; a passage fluidly connecting the inlet of the first body, the outlet of the first body, the inlet of the second body and the outlet of the second body, the passage being used for the liquid and air to travel therethrough; a filter provided on the lower face of the first body and the upper face of the second body, for filtering impurities present in the liquid; and a plurality of raised bumps provided between the filter and the upper face of the second body such that the filter and the upper face of the second body are separated from each other.

(2) There is also provided, the filter arrangement of clause (1) wherein: a compartment is created between the plurality of raised bumps.

(3) There is also provided, the filter arrangement of clause (1) wherein: the filter is surrounded by the first body and the second body.

(4) There is also provided, the filter arrangement of clause (1) wherein: one side of the filter is tightly attached to the lower face of the first body.

(5) There is also provided, the filter arrangement of clause (1) wherein: the filter is tightly attached to the plurality of raised bumps.

(6) There is also provided, the filter arrangement of clause (1) wherein: the filter is comprised of microfiber.

(7) There is also provided, the filter arrangement of clause (1) wherein: the first body includes a first coupling part engaged with the inlet of the first container, and the second body includes a second coupling part engaged with the inlet of the second container, and an antistatic element provided within the second coupling part, the antistatic element being protruded inwardly of the second container to keep a flow of the liquid distant from an inner wall of the second container.

(8) There is also provided, the filter arrangement of clause (7) wherein: the antistatic element has an inlet and an outlet, and the outlet has a smaller width than the inlet.

(9) There is also provided, the filter arrangement of clause (1) wherein: the plurality of raised bumps is provided between the filter and the lower face of the first body, separating the filter from the lower face of the first body.

(10) A water purification system comprising: a filter arrangement described in any of clauses (1) to (9); a first container connected to one end of the filter arrangement; and a second container connected to the other end of the filter arrangement, wherein the first container and the second container are at least partially made from a material that may cause volume deformation by the application of pressure.

(11) A filter arrangement placed between a first container for containing liquid and a second container, the filter arrangement comprising: a first body, into which an inlet of the first container for containing liquid is inserted and coupled together in a sealing manner; a second body, into which an inlet of the second container is inserted and coupled together in a sealing manner; and a main filter provided between the first body and the second body, for filtering the liquid.

(12) There is also provided, the filter arrangement of clause (11) wherein: the first body includes a first coupling part engaged with the inlet of the first container, the second body includes a second coupling part engaged with the inlet of the second container, and the filter arrangement comprises a passage running through the first body and the second body and having an inlet and an outlet, the passage being used for at least one of the liquid and air to travel from and through the inlet and the outlet of the passage.

(13) There is also provided, the filter arrangement of clause (11) comprising: a supplemental filter extending from the first coupling part and projecting toward the first container.

(14) There is also provided, the filter arrangement of clause (11) wherein: the supplemental filter has slanted sides and an inlet of the supplemental filter has a smaller width than the inlet of the passage.

(15) There is also provided, the filter arrangement of clause (11) wherein: the main filter comprises a filter; and at least one of a first plate placed on the filter and a second plate placed beneath the filter.

(16) There is also provided, the filter arrangement of clause (11) wherein: the passage running through the first body and the second body is provided with a first plate and a second plate, each plate having a plurality of holes formed therein.

(17) There is also provided, the filter arrangement of clause (11) comprising: an elastic element for sealing effects in a position at least one of: between the first body and the first container, between the second body and the second container, and between the first body and the second body.

(18) There is also provided, the filter arrangement of clause (11) comprising: a support placed beneath the main filter, the support being configured to allow at least one of water and air to travel therethrough.

(19) A water purification system comprising: a filter arrangement; a first container connected to one end of the filter arrangement; and a second container connected to the other end of the filter arrangement, wherein the first container and the second container are at least partially made from a material that may cause volume deformation by the application of pressure.

(20) There is also provided, the water purification system wherein: the filter arrangement is the filter arrangement described in any of clauses (11) to (18).

According to an exemplary embodiment of the filter arrangement of the present disclosure, the liquid can move from the center toward edges of the filter with smaller force, allowing more impurities to be filtered by the filter.

According to another exemplary embodiment of the filter arrangement of the present disclosure, a plurality of raised bumps can be used to create a distance between the upper face of the second body and the filter.

According to yet another exemplary embodiment of the filter arrangement of the present disclosure, a plurality of raised bumps can be used to create a distance between the lower face of the first body and the filter, and between the upper face of the second body and the filter.

According to yet another exemplary embodiment of the filter arrangement of the present disclosure, filtration of contaminated water can be done in a simple manner.

According to still another exemplary embodiment of the filter arrangement of the present disclosure, contaminated water can easily be filtered simply by placing the filter arrangement between containers that are widely available.

What is claimed is:

1. A filter arrangement provided with an inlet and placed between a first container for containing liquid and a second container having an inlet, the filter arrangement comprising:
a first body, into which an inlet of the first container for containing liquid is inserted and coupled together in a sealing manner, the first body including an inlet for receiving the liquid from the first container, an outlet through which the liquid flowing from the inlet is discharged, and a lower face formed on the outlet;
a second body, into which an inlet of the second container is inserted and coupled together in a sealing manner, the second body including an inlet for receiving the liquid, an outlet through which the liquid flowing from the inlet is discharged, and an upper face formed on the inlet;
a passage fluidly connecting the inlet of the first body, the outlet of the first body, the inlet of the second body and the outlet of the second body, the passage being used for the liquid and air to travel therethrough;
a filter provided on the lower face of the first body and the upper face of the second body, for filtering impurities present in the liquid; and
a plurality of raised bumps provided between the filter and the upper face of the second body such that the filter and the upper face of the second body are separated from each other.

2. The filter arrangement according to claim 1, wherein a compartment is created between the plurality of raised bumps.

3. The filter arrangement according to claim 1, wherein the filter is surrounded by the first body and the second body.

4. The filter arrangement according to claim 1, wherein one side of the filter is tightly attached to the lower face of the first body.

5. The filter arrangement according to claim 1, wherein the filter is tightly attached to the plurality of raised bumps.

6. The filter arrangement according to claim 1, wherein the filter is comprised of microfiber.

7. The filter arrangement according to claim 1, wherein the first body includes a first coupling part engaged with the inlet of the first container, and the second body includes a second coupling part engaged with the inlet of the second container, and an antistatic element provided within the second coupling part, the antistatic element being protruded inwardly of the second container to keep a flow of the liquid distant from an inner wall of the second container.

8. The filter arrangement according to claim 7, wherein the antistatic element has an inlet and an outlet, and the outlet has a smaller width than the inlet.

9. The filter arrangement according to claim 1, wherein the plurality of raised bumps is provided between the filter and the lower face of the first body, separating the filter from the lower face of the first body.

10. A water purification system comprising:
a filter arrangement described in claim 1;
a first container connected to one end of the filter arrangement; and
a second container connected to the other end of the filter arrangement,
wherein the first container and the second container are at least partially made from a material that may cause volume deformation by the application of pressure.
